(19) United States
(12) Patent Application Publication
(10) Pub. No.: US 2012/0290337 A1
(43) Pub. Date: Nov. 15, 2012

(54) METHOD AND SYSTEM FOR SHARING DEMAND-RESPONSE DATA

(75) Inventors: Roger HELMY, Burlington (CA); Jarrod Gregory CLARK, Burlington (CA)

(73) Assignee: TRAPEZE SOFTWARE INC., Mississauga (CA)

(21) Appl. No.: 13/242,845

(22) Filed: Sep. 23, 2011

(30) Foreign Application Priority Data
May 10, 2011 (CA) 2739777

(51) Int. Cl. G06Q 10/02

(52) U.S. Cl. 705/5

(57) ABSTRACT

A system and method for sharing demand-response data is provided. The system includes a communications interface and storage. The communications interface enables communication with transit operator systems of transit operators. The storage stores customer profiles from the transit operators for customers thereof, the customer profiles including customer data. Computer-executable instructions are executed by at least one processor of the computer system for synchronizing said customer profiles with said transit operator systems

This application claims priority from Canadian Application No. 2,739,777, filed on May 10, 2011, the contents of which are incorporated herein in their entirety by reference.

### FIELD OF THE INVENTION

The present invention relates generally to information systems. In particular, the invention relates to a method and system for sharing demand-response data between transit operators.

### BACKGROUND OF THE INVENTION

Demand-response trip scheduling is known. A customer contacts a transit operator that offers demand-response service and makes a trip request. In making the trip request, the customer discloses identification to enable the transit operator, as well as trip parameters. The trip parameters typically include a departure location, a destination and a desired departure time. The transit organization may maintain data for the customer regarding specific needs that the customer has. For example, some customers may be able to walk, whereas others may be confined to a wheelchair. By maintaining this information, the customer need not provide it each time he or she makes a trip request.

Making a trip request becomes more challenging, however, when the transit operator typically utilized by the customer does not offer demand-response service matching the requested trip. If two or more transit operators provide demand-response service in a region, the customer may have to contact both transit operators to determine if either transit operator provides demand-response service that matches the request trip. Additionally, where the customer desires to travel in a region that he usually does not travel in, he may not even know who to contact, and may be required to re-provide information regarding his specific needs.

It is therefore an object of the invention to provide a novel method and system for scheduling demand-response trips.

### SUMMARY OF THE INVENTION

In accordance with an aspect of the invention, there is provided a computer system for sharing demand-response data, comprising:

a communications interface for communicating with transit operator systems of transit operators;

a storage storing customer profiles from said transit operators for customers thereof, said customer profiles including customer data; and

computer-executable instructions executed by at least one processor of said computer system for synchronizing said customer profiles with said transit operator systems.

The computer system can include:

demand-response service data stored in said storage, said service area data defining service areas serviced by said transit operators and demand-response service attributes for each of said service areas.

The demand-response service attributes can include at least one of periods of operation, pick-up and drop-off rules for the service areas, service types and transfer points between neighboring service areas. A trip-booking module can be included for receiving a trip request and for identifying a subset of the transit operators that can service the trip request based on the demand-response service data. The trip-booking module can assemble a list of scheduling solutions for the trip request. The list of scheduling solutions can be ranked based on at least one of: passenger fare, total travel time, and transit operator cost. The trip-booking module can request scheduling solutions from the transit operator systems of the subset of transit operators. The transit operator systems can include at least one of customer cost and provider cost for the scheduling solutions. The trip-booking module can enable editing and cancellation of trips. The customer profiles can store transit requirements for the customers. The subset of the transit operators can be selected at least partially based on the requirements of the customer for which the trip booking is being planned.

The customer profiles can store transit requirements for the customers.

The computer system can include:

a graphical user interface for enabling transit operators to define said service areas via polygons overlaid on a street network.

The customer profiles can include a central customer ID used by the computer system and the transit operator systems to refer to a particular customer.

The computer-executable instructions when executed by the at least one processor can translate at least one data element in the customer profiles when synchronizing with at least one of the transit operator systems.

According to another aspect of the invention, there is provided a method for sharing demand-response data, comprising:

receiving customer profiles including customer data from transit operator systems;

storing said customer profiles from said transit operators in storage of a computer system; and

sending said customer profiles to other said transit operator systems.

The method can include:

storing demand-response service data in said storage, said service area data defining service areas serviced by said transit operators and demand-response service attributes for each of said service areas.

The demand-response service attributes can include at least one of periods of operation, pick-up and drop-off rules for the service areas, service types and transfer points between neighboring service areas.

The method can further include:

receiving a trip request; and

identifying a subset of said transit operators that can service said trip request based on said demand-response service data.

The method can further include:

assembling a list of scheduling solutions for said trip request.

The list of scheduling solutions can be ranked based on at least one of: passenger fare, total travel time, and transit operator cost.

The method can include:

requesting scheduling solutions from said transit operator systems of said subset of transit operators.

The method can include:

receiving said scheduling solutions with at least one of customer cost and provider cost for said scheduling solutions.

The method can include:

providing an interface for editing and cancelling trips.

The customer profiles can store transit requirements for the customers. The subset of the transit operators can be identified at least partially based on the requirements of the customer for which the trip booking is being planned.

The customer profiles can store transit requirements for the customers.

The method can include:

providing a graphical user interface for enabling transit operators to define said service areas via polygons overlaid on a street network.

The method can include:

storing a central customer ID used by said computer system and said transit operator systems to refer to a particular customer with said customer profiles.

The method can include:

translating at least one data element in said customer profiles when synchronizing with at least one of said transit operator systems.

### BRIEF DESCRIPTION OF THE DRAWINGS

Embodiments will now be described, by way of example only, with reference to the attached Figures, wherein:

FIG. 1 shows a high-level architecture of a computer system for sharing demand-response data, referred to as a trip-booking system, in accordance with an embodiment of the invention and its operating environment;

FIG. 2 shows a schematic diagram of the trip-booking system of FIG. 1;

FIG. 3 shows a graphical user interface of the trip-booking system of FIG. 1 for enabling definition of polygons representing service areas;

FIG. 4 shows a set of polygons representing service areas generated using the graphical user interface shown in FIG. 3; and

FIG. 5 is a flowchart of the general method of loading a customer profile using the trip-booking system of FIG. 1;

FIG. 6 is a flowchart of the general method of updating a customer profile via the trip-booking system of FIG. 1;

FIG. 7 is a flowchart of the general method of replicating customer data between the trip-booking system and transit operator systems of FIG. 1;

FIG. 8 is a flowchart of the general method of booking a trip via the trip-booking system of FIG. 1;

FIG. 9 is a flowchart of the general method of editing a trip booking via the trip-booking system of FIG. 1;

FIG. 10 is a flowchart of the general method of confirming or cancelling booked trips via the trip-booking system of FIG. 1;

FIGS. 11A and 11B show a flowchart of the general method of scheduling a trip via the trip-booking system of FIG. 1;

FIG. 12 shows the service areas of FIG. 4 with a first set of pick-up and drop-off locations;

FIG. 13 shows the service areas of FIG. 4 with a second set of pick-up and drop-off locations;

FIG. 14 shows the service areas of FIG. 4 with a third set of pick-up and drop-off locations;

FIG. 15 is a flowchart of the general method of cancelling or removing a scheduled trip via the trip-booking system of FIG. 1; and

FIG. 16 is a flowchart of the general method of updating scheduled bookings via the trip-booking system of FIG. 1.

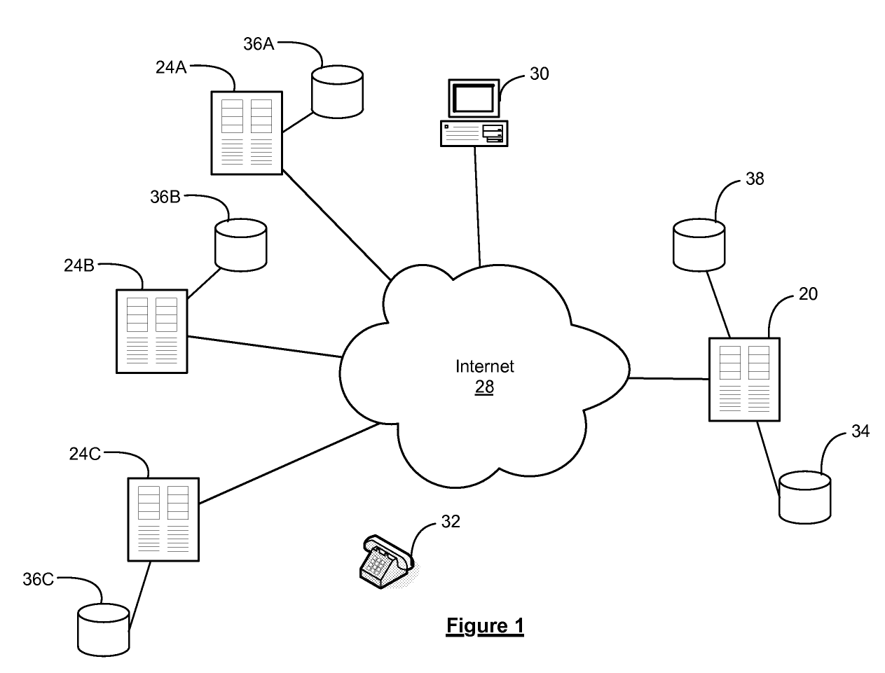

### DETAILED DESCRIPTION OF THE EMBODIMENTS

A computer system for sharing demand-response data in accordance with an embodiment of the invention is shown in communication with a number of transit operator systems 24A, 24B and 24C via the Internet 28. The computer system also enables trips to be booked across transit operators, and is thus referred to as trip-booking system 20. The trip-booking system 20 may be operated by one or more transit operators or by an independent party. The transit operator systems 24 are operated by transit operators, and act as clients to the trip-booking system 20. A personal computer 30 operated by a customer is connected to the Internet 28, enabling the customer to access demand-response scheduling websites operated by the transit operator systems 24A, 24B, 24C. A telephone handset 32 is shown in communication with transit operator system 24C via a public switched telephone network. The telephone handset 32 may be used to access an interactive voice response application executed by the transit operator system 24C or, alternatively, may be used to call a service representative of a transit operator who can access the transit operator system 24C to schedule trips, etc. For purposes of simplicity, customer interaction will be described as being received via telephone handset 32 by a service representative.

The trip-booking system 20 manages a central customer database 34 that stores customer profiles for each customer. In addition, each transit operator system 24 manages a local customer database 36 that stores customer profiles that generally mirror the customer profiles stored in the central customer database 34. The trip-booking system 20 also maintains a trip-booking database 38 that houses data for trip bookings.

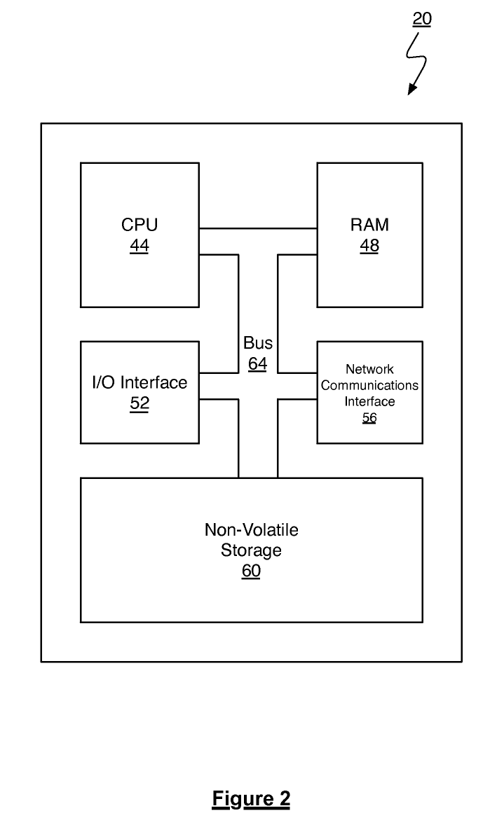

FIG. 2 shows various physical elements of the trip-booking system 20. As shown, the trip-booking system 20 has a number of physical and logical components, including a central processing unit (“CPU”) 44, random access memory (“RAM”) 48, an input/output (“I/O”) interface 52, a network communications interface 56, non-volatile storage 60, and a local bus 64 enabling the CPU 44 to communicate with the other components. The CPU 44 executes an operating system and computer-executable instructions to provide trip-booking software including a number of software modules as will be described below. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network communications interface 56 permits communication with other systems. Non-volatile storage 60 stores the operating system and programs, including computer-executable instructions for implementing the trip-booking software, and data used by the software. During operation of the trip-booking system 20, the operating system, the computer-executable instructions and the data may be retrieved from the non-volatile storage 60 and placed in RAM 48 to facilitate execution.

The trip-booking software includes a trip-booking module for handling the scheduling, editing and cancellation of trips for customers, a graphical user interface for defining service areas, and a data synchronization module for synchronizing customer data between the trip-booking system 20 and the transit operator systems 24.

When a customer, such as a user of the telephone handset 32, desires to book a trip, he calls a service representative of a transit operator. The service representative interacts with a transit operator system 24 maintained by the particular transit operator to enter a trip request made verbally by the customer. The service representative will ask the customer to provide some identifying information, and attempts to retrieve the customer's profile. If the customer is not in a local customer database 36 of the transit operator system 24 or in a central customer database 34 maintained by the trip-booking system 20, the service representative obtains registration information from the customer, such as their name, residential address, and any special requirements that the customer may have and enters it into the transit operator system 24. Changes made to customer data in the local customer database 36 managed by a transit operator system 24 or in the central customer database 34 managed by the trip-booking system 20 are propagated. The service representative enters in the trip request communicated by the customer into the transit operator system 24. In turn, the transit operator system 24 transmits the trip request together with customer information to the trip-booking system 20. The trip-booking system 20 determines which transit operators can provide service, and contacts those transit operators to obtain tentative scheduling information. Once the trip-booking system 20 has generated a list of options for the customer to select from, it returns them to the transit operator system 24. The list of options can include solutions provided by other transit operators apart from the transit operator that the customer contacted. The service representative reads the options to the customer on the phone and enters the option selected by the customer. Upon receiving the customer's selection, the transit operator system 24 indicates the selected option to the trip-booking system 20. In response, the trip-booking system 20 books the selected scheduling solution with the transit operator(s) through which that scheduling solution is offered and records the costs.

### Setup

In order to schedule demand-response trips for a particular transit operator, the trip-booking system 20 requires information regarding the geographic areas served by the transit operator, as well as any demand-response service attributes that describe the transit operator's service for that geographic area. In addition, the trip-booking system 20 requires other information, such as, for example, transit operator translation tables, described hereinbelow, and the fare rates for customers.

To enable transit operators to register their services with the trip-booking system 20, the transit operators are provided with login credentials for the trip-booking system 20. Upon logging in, the transit operator is presented with a control panel that permits them to register or edit their demand-response services, as well as monitor various metrics. The control panel allows the transit operator to define their client data elements with the use of the translation tables, their service areas, service times, and the types of services to be provided.

When a transit operator is first being set up on the trip-booking system 20, they can register the demand-response services they provide by geographic service area. This is done via a web-based graphical user interface (“GUI”) that enables the transit operator to identify a service area on a map that includes a street network, and a set of controls that allow the transit operator to input demand-response service attributes for the identified service area.

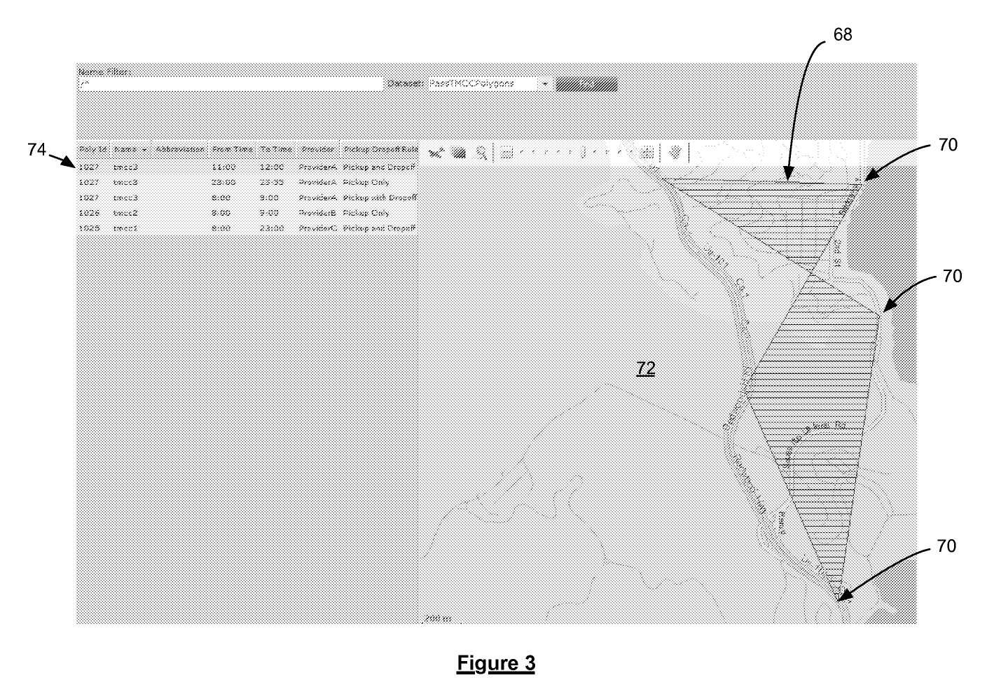

FIG. 3 shows an exemplary view of a portion of the GUI for enabling the transit operator to define a polygon identifying the geographic area of demand-response service (or “service area”). A polygon 68 is shown. The polygon 68 is a defined boundary for a specific geographic area on the Earth's surface. The shape of the polygon 68 is defined by vertices 70 that can be created, viewed and edited visually on an interactive map 72 of the GUI. One or more sets of demand-response service attributes can be inputted in a service area attribute pane 74 by the transit operator for each geographic area identified. In the illustrated example, a transit operator has specified that full service is provided to the geographic area defined by the polygon 68 between the hours of 1100 and 1200 and between the hours of 0800 and 0900, and that pickup-only service is provided between the hours of 2300 and 2355. Attributes can include the following information:
service day and time periods
pick-ups only/drop-offs only/pick-ups or drop-offs/pick-ups and drop-offs/pick-ups with drop-offs
service types (wheelchair, etc.)

The GUI enables a transit operator to manually create and maintain polygon information for polygons that define service areas. Each defined polygon is assigned a unique system-generated identification number. When polygons are being defined, they are superimposed over a street network map to enable the transit operator to visually ensure that the polygon corresponds to the target service area. In some cases, transit operators may be permitted to view and copy the polygons defined by other transit operators.

The drawing tools provided in the GUI enable a user to define a polygon free-form, to snap vertices to the closest street vertex or to snap the polygon sides to a street.

Polygons can be marked as “active” or “inactive”. Active polygons are used to represent service areas that are live, whereas inactive polygons are used to represent service areas that are not being utilized at that time.

The trip-booking system 20 provides various screens with controls for enabling a transit operator to input demand-response service attributes for a service area. The controls enable the transit operator to identify, for each service area:
the date range over which service is provided
the days of the week during which service is provided
the times of the day during which service is provided
pick-up and drop-off rules for the service area (pick-up only, drop-off only, pick-up and drop-off, pick-up or drop-off, pick-up with drop-off)
service types (e.g., American Disability Act service, Medicaid service)
transfer points between neighboring service areas that are then utilized as meeting places for vehicles to exchange passengers, where different transit operators are used
Used to identify the location of all geocoded addresses that enter the system [I don't understand what is being provided by the transit operator here]

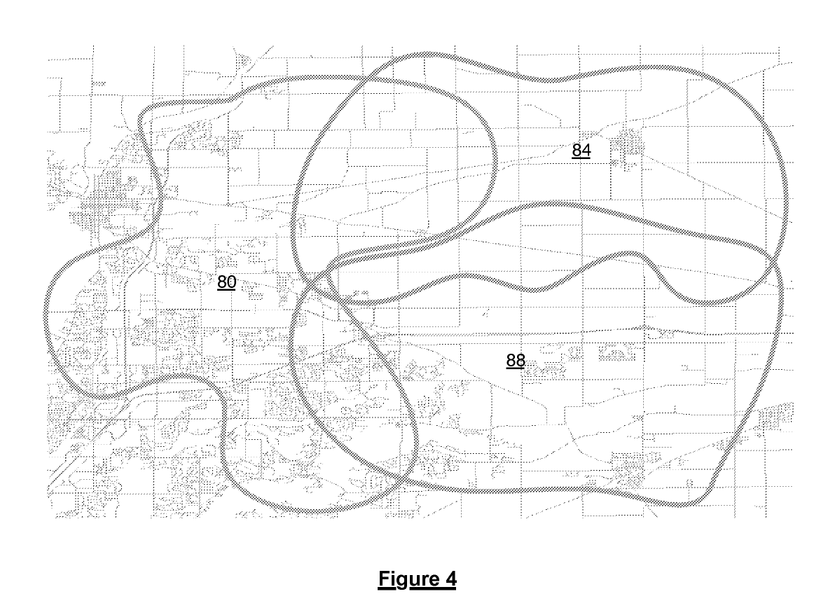

FIG. 4 shows an exemplary set of polygons defining service areas for two demand-response operators, transit operator A and transit operator B. In this example, three service areas are defined: a west service area 80, a north service area 84 and a south service area 88.

Transit operator A also provides the following demand-response service for the west service area 80:
pick-ups and drop-offs on Mondays through Fridays from 0600 to 2200 for Medicaid and ADA
pick-ups and drop-offs on Saturdays from 0900 to 2000 for ADA
pick-ups and drop-offs on Sundays from 0900 to 1800 for Veterans and ADA

Transit operator A provides the following demand-response service for the north service area 84:
drop-offs only on Mondays through Fridays from 0600 to 2200 for all services
drop-offs only on Saturdays from 0900 to 2000 for all services
drop-offs only on Sundays from 0900 to 1800 for all services

Transit operator B provides the following demand-response service for the south service area 88:
pick-ups and drop-offs on Mondays through Fridays from 0600 to 2200
pick-ups and drop-offs on Saturdays from 0900 to 2000
pick-ups and drop-offs on Sundays from 0900 to 1800

Transit operator B also provides the following demand-response service for the north service area 84:
pick-ups only on Mondays through Fridays from 0600 to 2200
pick-ups only on Saturdays from 0900 to 2000
pick-ups only on Sundays from 0900 to 1800

### Customer Profiles

The trip-booking system 20, and the data synchronization module in particular, maintains a central customer database 34 that contains a master list of customer profiles from all participating transit operator systems 24. The central customer database 34 is a relational database maintained in non-volatile storage 60 of the trip-booking system 20, although other manners of storing customer data can be employed, such as flat data tables, etc.

When a customer applies for service with one of the transit operators, all pertinent information about that customer is entered as a customer profile into the transit operator system 24 maintained by the transit operator contacted by the customer. The transit operator system 24 generates a local customer ID for the customer and stores it, together with the customer profile, in the local customer database 36. It then forwards the customer information, including the local customer ID, to the trip-booking system 20. The data synchronization module executing on the trip-booking system 20 generates a unique central customer ID and stores it, together with the customer information and the local customer ID received, in the central customer database 34 as a customer profile. The central customer ID is forwarded by the trip-booking system 20 to the transit operator system 24. This data is subsequently used each time a trip is booked for that customer. The unique central customer ID is used by all transit operator systems 24 when referring to the particular customer.

Customer profiles include the following for each customer:
names (first, middle, last, title, nickname)
date of birth
personal information (e.g., disability type, mobility aid, space type requirement)
address (e.g., home, work, emergency)
telephone numbers (work, home, mobile)
contacts (e.g., home, work, emergency)
service status (e.g., ADA, Medicaid)
vehicle type exclusions
load and unload times
comments (general, private, scheduling)
gender
transport modes (e.g., fixed-route service, demand-response service, flexible-route service)
disabilities
central customer ID
local customer ID
permanent conditions
default space type (e.g., ambulatory, wheelchair)
escort option (mandatory, optional, not allowed, co-driver required)
preferred language

A data specification is provided to transit operators for the supported data elements for each of these categories maintained within the central customer database 34. If, however, the trip-booking system 20 does not support a data element that is required for a particular transit operator, the administrator for the particular transit operator can create user defined fields to capture the information. The administrator can also flag data elements as mandatory. This means that each transit operator collecting information from a customer will need to ensure that, when transmitting new customer profiles to the trip-booking system 20, data is provided for the mandatory data elements.

Since each transit operator operates under its own specific business policies and procedures, it is unrealistic to expect that all transit operators will adhere to a common data standard. For example, one transit operator may refer to a customer's defined space type as “Large Electric Wheelchair”, while another transit operator may refer to the same data element as “Scooter”. As a result, the trip-booking system 20 hosts a number of translation tables for equivocating data elements received from the various transit operators. The table below provides an example of such a translation table:

| Generic Central | Transit | Transit | Transit |
|---|---|---|---|
| Term | Operator A | Operator B | Operator C |
| Ambulatory | Amb | Walking | Ambulatory |
| Wheelchair | Chair | Wheelchair | Manual Chair |
| Scooter | Large Chair | Electric Chair | Scooter |
| Transferable | Amb & Chair | Transferable | Transferable |

Translation tables contain a “Generic” central term. It is the responsibility of the administrator for a transit operator to maintain the proper translation between that transit operator and all other transit operators. In this example, a “Space Type” translation table is used. If transit operator A registers a new customer and this customer's defined space type is “ambulatory”, the space type being transmitted to the trip-booking system 20 would come in the form of “amb”. The trip-booking system then utilizes the translation table to register the customer as “ambulatory” in that customer's profile in the central customer database 34. As the trip-booking system 20 replicates the new customer registration record to transit operators, it ensures that the correctly translated space type information is sent so that the customer data will be consistent with that maintained and understood by the transit operator system 24. For example, if the customer registration record was to be replicated to transit operator B, the space type information would be sent as “walking”.

The following data elements have a corresponding translation table:
mobility aids (e.g., walker, cane)
vehicle type exclusions (e.g., van lift, car)
disabilities (e.g., visual impairment)
space type (e.g., ambulatory, wheelchair)
preferred language (e.g., English, Spanish)
address types (e.g., home, work)
contact types (e.g., emergency, work)
contact device types (e.g. home telephone number, work telephone number)

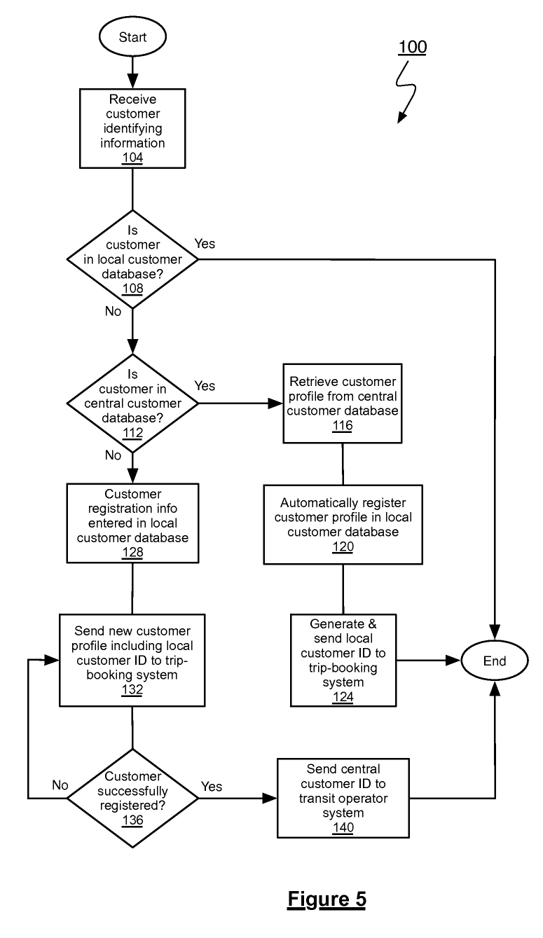

FIG. 5 is a flowchart of the general method of loading a customer profile using the trip-booking system 20 generally shown at 100. Upon receipt of some information from the customer, a transit operator system 24 searches the central customer database 34 on the trip-booking system 20 to identify an existing customer profile for the particular customer, if one exists.

As the customer profile in the central customer database 34 may not be replicated in the local customer database 36, the transit operator system 24 searches for and synchronizes the customer information.

The method 100 commences with the receipt of identifying information from a customer by a service representative for a transit operator (104). When a customer calls the service representative to place a trip request, the service representative obtains the customer's name and other information needed from the customer. The service representative then enters the customer name and residential address into the transit operator system 24 to determine if a corresponding customer profile already exists in the local customer database 36 maintained by the transit operator system 24 (108). The transit operator system 24 enables searching for customers by name, local customer ID, central customer ID, date of birth, telephone number and address. If a corresponding customer profile exists in the local customer database 36, the method 100 ends. If, instead, a corresponding customer profile does not exist in the local customer database, the transit operator system 24 sends a query to the trip-booking system 20 to determine if the customer is in the central customer database 34 that it maintains (112). The customer may be in the central customer database 34, for example, if the customer has registered with another transit operator that participates. If the customer is in the central customer database 34, the trip-booking system 20 transmits the customer profile, including the customer data, to the requesting transit operator system 24 (116). Once the customer profile is retrieved from the trip-booking system 20, the transit operator system 24 automatically registers the customer profile received from the trip-booking system 20 (120). Included in the customer profile is the central customer ID used by the trip-booking system 20 to uniquely identify the customer. The transit operator system 24 then generates a local customer ID for the customer and forwards it to the trip-booking system 20 (124). The transit operator system 24 also stores the local customer ID in the customer profile in the local customer database 36. Upon transmitting and storing the local customer ID, the method 100 ends.

If, instead, a corresponding customer profile does not exist within the central customer database 34 maintained by the trip-booking system 20, customer registration information is entered into the transit operator system 24 (128). The service representative prompts the customer for registration information and enters it into the transit operator system 24 to be stored in a customer profile. Once the customer registration information is entered into the transit operator system 24, the transit operator system 24 transmits the customer profile to the trip-booking system 20, including a local customer ID generated by the transit operator system 24 (132). The trip-booking system 20 then generates a unique central customer ID for the customer. It is then determined if the customer is successfully registered in the trip-booking system 20 (136). If not, the trip-booking system 20 reports an error to the transit operator system 24, and then waits for the transit operator system 24 to transmit a revised customer profile at 132. If, instead, the customer is successfully registered on the trip-booking system 20, the trip-booking system 20 sends the central customer ID it generated to the transit operator system 24 (140). The central customer ID is then stored in the local customer database 36 so that the transit operator system 24 may use it to identify the customer to the trip-booking system 20 at later times.

When a change occurs in the customer's data, such as when the customer changes residences, the corresponding customer profile is revised by a service representative in the local customer database 36. Upon revising the customer profile locally, the transit operator system 24 transmits it to the trip-booking system 20 to update the central customer database 34 and for later propagation to other transit operator systems 24.

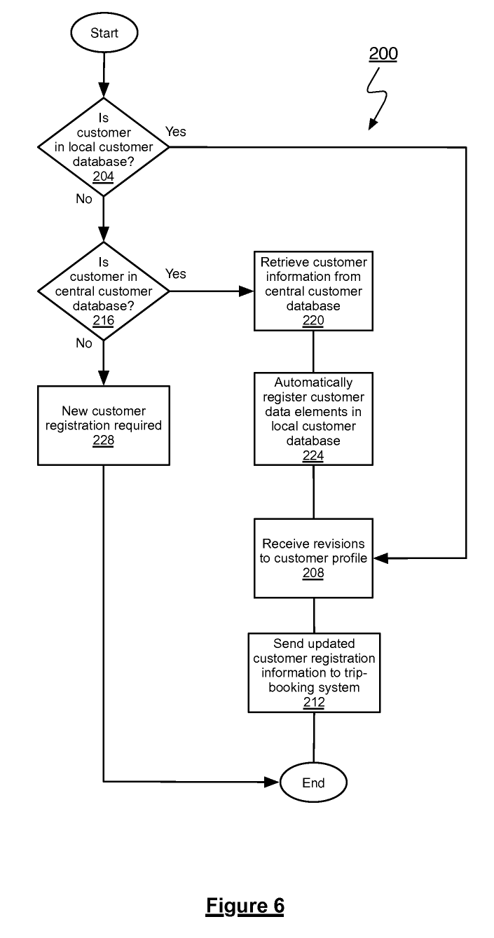

FIG. 6 illustrates the method of updating a customer profile generally at 200. The method 200 commences with the search for a corresponding customer profile in the local customer database 36 of the transit operator system 24 (204). If it is determined that a corresponding customer profile is in the local customer database 36 managed by the transit operator system 24 at 204, the customer profile in the local customer database 36 maintained by the transit operator system 24 is retrieved and updates are received (208). Once the custom profile has been revised at 208, it is sent to the trip planning system 20 (212). The trip planning system 20 incorporates the revisions to the customer profile into the central customer database 34, after which the method 200 ends.

If, instead, a corresponding customer profile is determined to not be in the local customer database at 204, it is determined if a corresponding customer profile is in the central customer database 34 maintained by the trip-booking system 20 (216). If a corresponding customer profile is in the central customer database 34, it is retrieved from the central customer database 34 (220). The retrieved customer profile is then automatically registered in the local customer database 36 maintained by the transit operator system 24 (224). Once the customer profile is registered in the local customer database 36, the mess that 200 proceeds to 208, wherein revisions to the customer profile are received. If, instead, a corresponding customer profile is also not in the central customer database 34 maintained by the trip-booking system 20, it is determined that a new customer registration is required (228). The process of obtaining a new customer registration is similar to steps 128 to 140 in method 100. Once the customer is registered in the central customer database 34, the method 200 ends.

The trip-booking system 20 ensures that all transit operator systems 24 have the most recent client registration information. This is accomplished by automatically pushing client information updates from the trip-booking system 22 to the transit operator systems 24. If the trip-booking system 20 is not successful in pushing the client information update to a transit operator system 24, the trip-booking system 20 will continuously attempt to send the information until the transit operator system 24 has successfully received the information. This ensures that all transit operators systems 24 have the most recent client registration data.

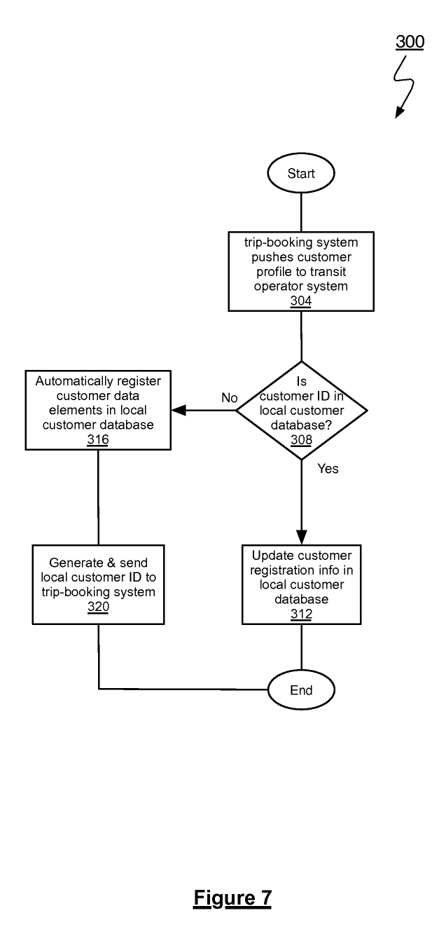

FIG. 7 shows the method of replicating customer data between the trip-booking system 20 and a transit operator system 24 generally at 300. The method 300 commences with the trip-booking system 20 pushing an updated customer profile to the transit operator system 24 (304). The customer profile includes a central customer a ID that uniquely identifies the customer in the central customer database 34. The transit operator system 24 then determines if there is a corresponding customer profile in the local customer database 36 that it maintains (308). In particular, the transit operator system 24 determines if the local customer ID occurs in any of the customer profiles in the local customer database 36. If there is a corresponding customer profile in the local customer database 36 at 308, the customer profile in the local customer database 36 is updated to reflect any changes evident in the customer profile from a trip-booking system 20 (312), after which the method 300 ends. If, instead, the transit operator system 24 determines that a corresponding customer profile doesn't exist in the local customer database 36 at 308, it automatically registers the customer profile in the local customer database (316). In registering the customer profile, the transit operator system 24 generates and stores a unique local customer ID in the local customer database 36. The transit operator system 24 then forwards the unique local customer ID that it generated to the trip-booking system 20 (320). The trip-booking system 20 stores the local customer ID received from the transit operator system 24 in the central customer database 34 with the customer profile, after which the method 300 ends.

The trip-booking system 20 enables a user to identify what transit operators systems 24 have successfully registered new customer profiles and updates. This information is only made visible on the trip-booking system 20 via a client registration user interface. Each customer profile has a corresponding transit operator system 24 “acknowledgment” record indicating what transit operator systems 24 successfully received the updates.

Once a customer profile is present in the local customer database 36 and central customer database 34, a trip can be booked for the customer. The customer communicates a trip request to a service representative who then enters the trip-booking request into a transit operator system 24. Every trip booking that the trip-booking system 20 processes, via a real-time interface, is maintained within the trip-booking database 38 in non-volatile storage 60 as a trip-booking record. Each successful entry of a trip booking causes the trip-booking system 20 generates a unique booking ID and delivers it to the transit operator system 24. This unique booking ID is used by all transit operator systems 24 when referring to the trip-booking record.

Trip-booking records contain the following information:
booking information (e.g., trip date, purpose, mobility aids)
booking leg information (e.g., pick-up and drop-off addresses, comments)
booking activity (e.g., passengers traveling, space type requirements)
faring and funding information (e.g., fare codes, provider costs)

In addition, the trip-booking system 20 also enables transit operators to create user-defined fields as required by them. Administrators will also be able to flag data elements as mandatory. This means that each participating transit operator will need to ensure that when transmitting booking information to the trip-booking system 20, data is provided for the mandatory data elements.

As previously noted, the trip-booking system 20 translates these fields as required so that they are understood by each transit operator system 24.

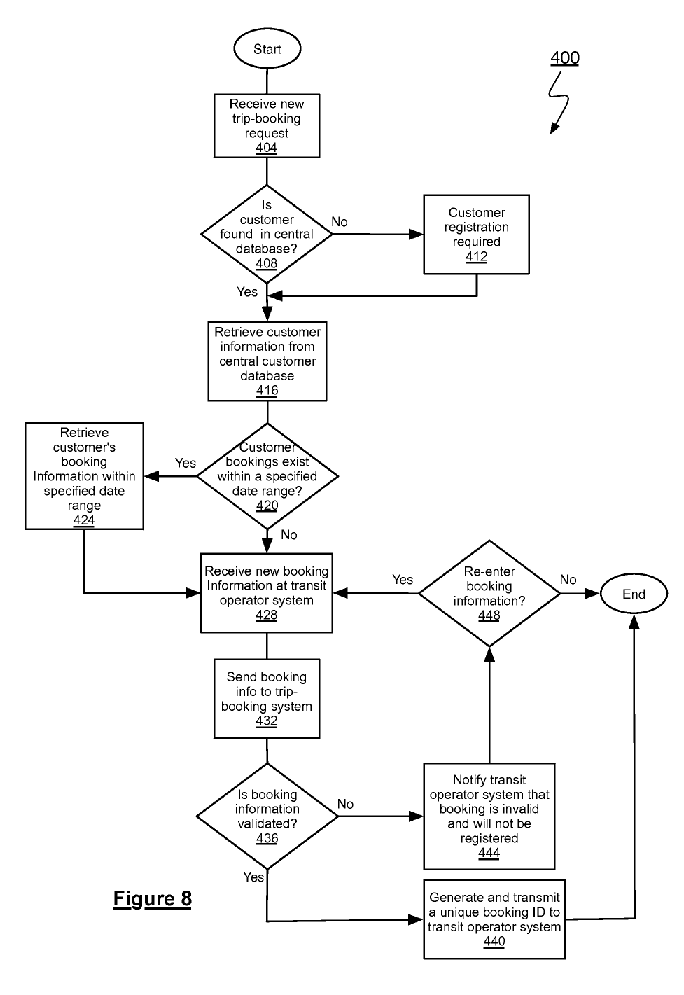

FIG. 8 shows the method of booking a trip for a customer using the trip-booking system 20 generally at 400. A trip-booking request is received from the customer and identifying information for the customer is entered by the service representative into the transit operator system 24 (404). The transit operator system 24 then determines if the customer is in the central customer database 34 maintained by the trip-booking system 20 (408). The service representative enters identifying information from the customer into the transit operator system 24 to locate the customer in the central customer database 34. The transit operator system 24 checks if a corresponding customer profile exists in the local customer database 36 and has a central customer ID, thus indicating that a corresponding customer profile exists in the central customer database 34. The transit operator system 24 queries the trip-booking system 20 to determine if the customer is already registered in the central customer database 34. The query sent by the transit operator system 24 includes identifying information about the customer to enable the trip-booking system 24 to locate a corresponding customer profile, if one exists. If a corresponding customer profile does not exist in the central customer database 34, it is determined that registration of the customer in the central customer database 34 maintained by the trip-booking system 20 is required (412). The process of obtaining a new customer registration is similar to steps 128 to 140 in method 100. Once the customer is registered in the central customer database 34, the customer profile is retrieved from the central customer database 34 (416). The trip-booking system 20 retrieves the corresponding customer profile and forwards it to the transit operator system 24 that requested it. The transit operator system 24 then queries the trip-booking system 20 to determine if there are bookings for the particular customer within a specified date range (420). The transit operator system 24 uses the central customer ID from the customer profile to query the trip-booking system 20. If it is determined that there are pre-existing bookings for the customer in the specified date range, the information about the customer's bookings within the specified date range is retrieved (424). This enables the service representative to verify that a booking does not already exist for the customer's desired trip. The service representative can review any existing bookings to ensure that a booking corresponding to the customer's desired trip does not already exist on the trip-booking system 20. The service representative then inputs booking information into the transit operator system (428). If the desired trip corresponds to an existing booking, the service representative can edit the booking. If a corresponding trip booking does not exist on the trip-booking system 20, the service representative inputs the new booking information into the transit operator system 24. Upon entry of the booking information, the transit operator system 24 transmits the new booking information to the trip-booking system 20 for registration in the trip-booking database 38 (432). The trip-booking system 20 then determines if the received booking information is valid (436). If the trip-booking information is determined to be valid at 436, the trip-booking system 20 generates a unique booking ID and transmits it to the transit operator system 24 (440). The trip-booking system 20 stores the trip booking in the trip-booking database 38, after which the method 400 ends. If, instead, the received booking information is determined to be invalid at 436, the trip-booking system 20 notifies the transit operator system 24 that the booking information is invalid and will not be registered in the trip database (444). The service representative is then given the opportunity to elect re-entry of the correct booking information via the transit operator system 24 (448). If the service representative elects to re-enter or correct the booking information, the method 400 returns to 428, at which point the service representative enters the booking information. If, instead, the service representative elects to not re-enter the booking information at 448, the method 400 ends.

The service representative can edit existing trip bookings through the transit operator system 24. Trip bookings may be edited for a number of reasons. For example, a customer may desire to change the time of a trip. Trip bookings are selected for editing based on the customer with whom they are associated. The service representative retrieves the customer's information, including existing bookings, and then can select a booking to edit.

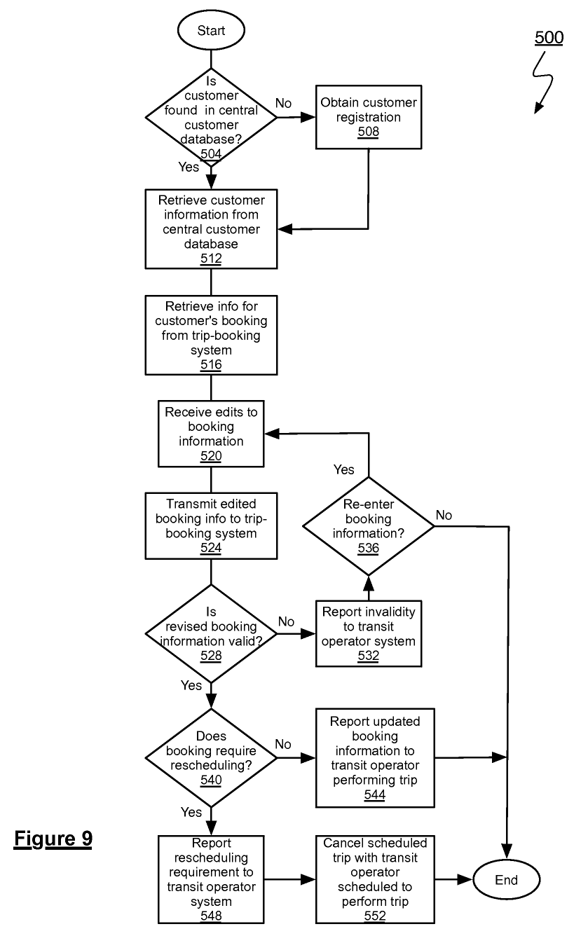

FIG. 9 shows the method of editing a trip booking generally at 500. The method 500 commences with the determination of whether the customer is found in the central customer database 34 (504). The service representative enters identifying information from the customer into the transit operator system 24 to locate the customer in the central customer database 34. The transit operator system 24 checks if a corresponding customer profile exists in the local customer database 36 and has a central customer ID, thus indicating that a corresponding customer profile exists in the central customer database 34. If a corresponding customer profile is not found in the central customer database 34 at 504, customer registration is obtained (508). The process of obtaining a new customer registration is similar to steps 128 to 140 in method 100. Once the customer is registered in the central customer database 34, the customer information is retrieved from the central customer database 34 (512). The customer information can include the customer's name, address, contact information, etc. Next, the information for the customer's booking(s) within a specified date range is retrieved from the trip-booking system 20 (516). Upon receipt of the information for the customer's booking(s) in the specified date range, the transit operator system 24 presents the bookings on a screen enabling the service representative to select one. Once a trip booking is selected, the trip-booking information is presented on a screen for editing by the service representative. The service representative can select a booking and review the information with the customer to ensure that it's accurate and reflects the trip desired to be made by the customer. Any edits to booking information is then received (520). If there are any changes to the information, the service representative can make them directly to the information being presented. Once the edits are entered, the service representative can submit the revised booking information to the trip-booking system 20 by activating a button on the interface of the screen, after which the edited booking information is transmitted to the trip-booking system 20 (524). The trip-booking system 20 determines if the revised booking information is valid (528).

If the revised booking information is found to be invalid at 528, the invalidity of the revised booking information is reported by the transit booking system 20 to the transit operator system 24 (532). An error message is presented to the service representative on the screen of the transit operator system 24 to indicate what revised booking data in particular is invalid. The service representative can verify the information entered on the screen and discuss any issues with the customer, if necessary. The service representative can either correct the revised trip-booking information or can choose to cancel the revisions to the booking information (536). The service representative can elect to edit the booking information onscreen and activate an “update” button to submit the revised trip-booking information, or alternatively can activate a “cancel” button to cancel editing the trip-booking information. If the service representative elects to resubmit revised trip-booking information at 536, the method 500 returns to 520 at which the edits are received by the trip-booking system 20. If, instead, the service representative elects to cancel the editing of the trip-booking information at 536, the method 500 ends.

If, instead, the revised booking information is found to be valid at 528, the trip-booking system 20 determines if the trip booking requires rescheduling (540). If, for example, a comment is added to the booking, no reschedule is required. If there is a change in address or any information that impacts the customer's desired trip, such as a change in the requested time or mobility aids required (i.e., anything that impacts scheduling times, space required, origin, destination, etc.), the trip booking is rescheduled. If the trip-booking system 20 determines that the trip booking does not require rescheduling, it reports the updated trip-booking information to the transit operators performing the trip. If the trip booking requires rescheduling as a result of the edited trip-booking information, the rescheduling requirement is reported to the transit operator system 24 (548). The trip-booking system 20 tells the transit operator system 24 that the trip booking will be unscheduled and will require rebooking. Upon receiving the notification that the trip will require rebooking, the transit operator system 24 attempts to rebook the trip using a process generally similar to method 400. After reporting, the trip-booking system 20 cancels the scheduled trip with the transit operator(s) scheduled to perform the trip (552), after which the method 500 ends.

When customers desire to confirm or cancel the trip booking, they contact a service representative of one of the transit operators who then interacts with a transit operator system 24 to help the customer do so.

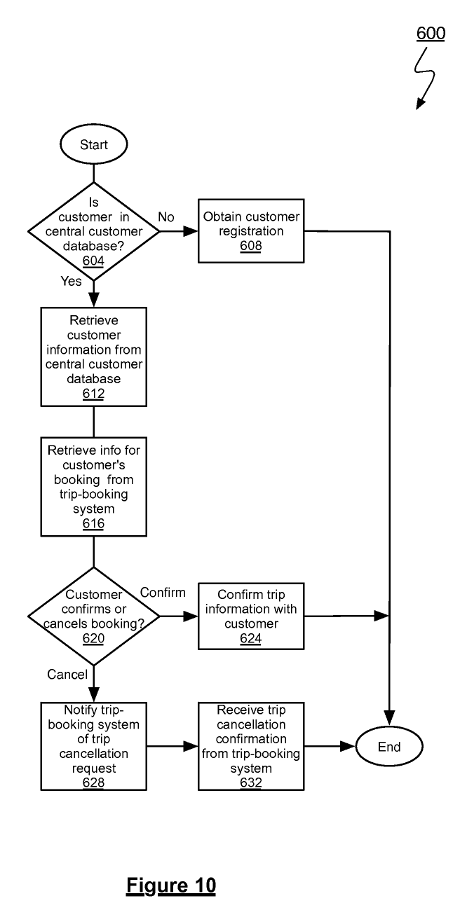

FIG. 10 shows the general method of confirming or cancelling booked trips at 600. Upon receiving identifying information from a customer, the service representative determines if a corresponding customer profile exists in the central customer database 34 (604). In particular, the service representative enters the identifying information given by the customer into a transit operator system 24 and directs the transit operator system 24 to locate the customer in the central customer database 34. The transit operator system 24 queries the trip-booking system 20 to determine if a corresponding customer profile is in the central customer database 34, and the trip-booking system 24 responds that a corresponding customer profile is either located or is not located. If a corresponding customer profile is not located in the central customer database 34, a customer registration is obtained for the customer (608), after which the method 600 ends.

If, instead, a corresponding customer profile is found in the central customer database 34 at 604, the transit operator system 24 retrieves the customer profile from the central customer database 34 (612). After retrieving the customer profile from the central customer database 34, the transit operator system 24 retrieves information for the customer's bookings for a specified date range from the trip-booking system 20 (616). Once the transit operator system 24 has retrieved the customer information and information regarding the customer's booking(s) in the specified date range, the transit operator system 24 presents the retrieved information on one or more screens. Once a trip is selected, the service representative confirms or cancels the selected trip on direction of the customer by activating a “confirm” button or a “cancel” button (620). If the confirm button is activated, the transit operator system 24 transmits the confirmation to the trip-booking system 20. If the trip booking is confirmed, the service representative confirms the trip with the customer (624), after which the method 600 ends. If, instead, the customer wishes to cancel the trip booking, the customer notifies the service representative who notifies the trip-booking system 20 of the trip cancellation request (628). In particular, upon the “cancel” button being activated, the transit operator system 24 transmits a cancellation confirmation to the trip-booking system 20. The trip cancellation confirmation is then received from the trip-booking system 20 (632). Upon receiving confirmation of the cancellation, the service representative confirms the cancellation with the customer, after which the method 600 ends.

Once a trip booking has been successfully saved on the trip-booking system 20, transit operator systems 24 may request to schedule the booking via a real-time interface.

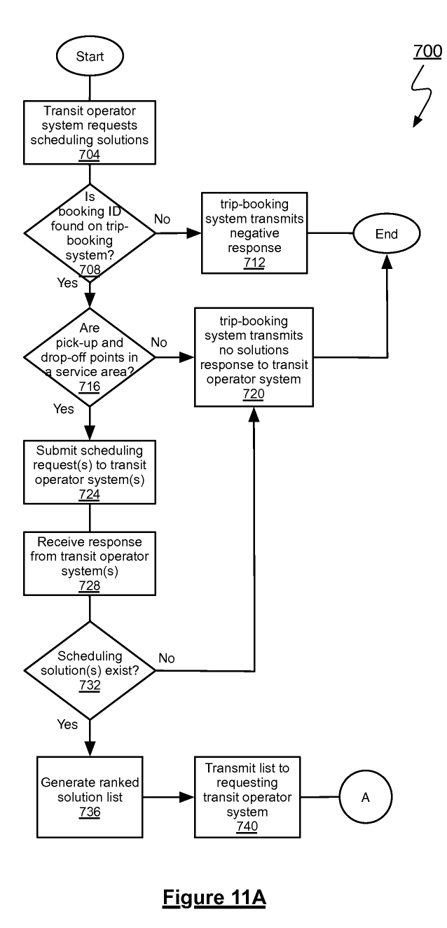

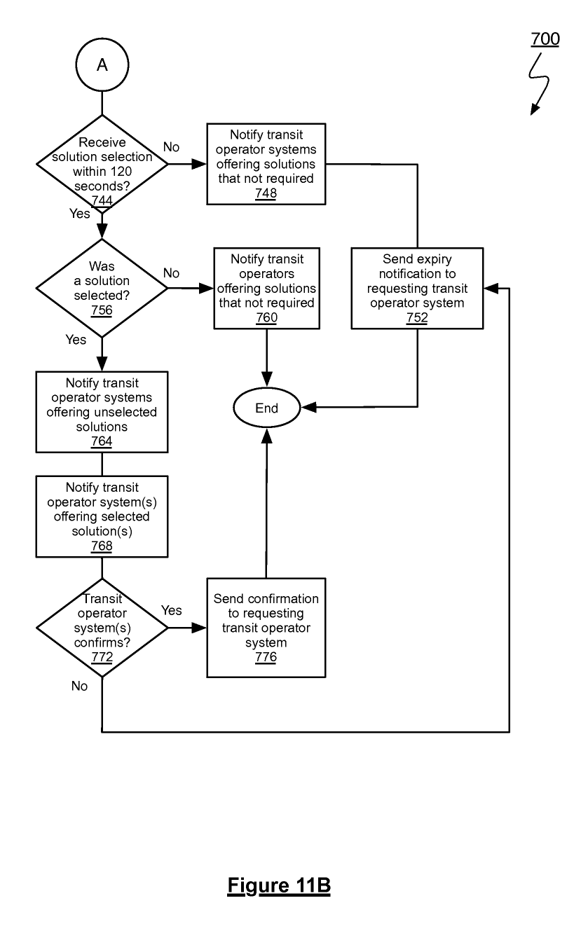

FIGS. 11A and 11B shows the general process of scheduling of a trip using the trip-booking system 20 at 700. The method 700 commences with a transit operator system 24 requesting scheduling solutions for a desired trip (704). The transit operator system 24 transmits a trip-booking ID received from the trip-booking system 20 to the trip-booking system 20 with the request, enabling the trip-booking system 20 to uniquely identify which trip booking the request is in respect of.

Upon receipt of the trip-booking request, the trip-booking system 20 determines if there's a trip that has been previously scheduled for the customer that matches the trip-booking request (708). The trip-booking system 20 searches the registered trip bookings for the trip-booking ID included with the trip-booking request. If the trip-booking ID is not found, the trip-booking system 20 transmits a negative response (712), after which the method 700 ends. If, instead, the trip-booking system 20 locates the trip booking corresponding to the trip-booking ID transmitted with the request, the trip-booking system 20 determines if the pick-up and drop-off points are within a service area defined by the transit operators via the polygons and the demand-response service attributes for those service areas specified by the transit operators (716).

By utilizing the polygon information defining service areas and the demand-response service parameters defined by the transit operators, the trip-booking system 20 is able to determine which providers are appropriate scheduling solution candidates for the trip booking and the customer requirements. In doing so, the trip-booking system 20 uses the following polygon service area attributes:
designated transfer points between neighboring provider zones: these transfer points are then utilized as meeting places for vehicles to exchange passengers; and
the location of all geocoded addresses that enter the system.

If either of the trip pick-up and drop-off locations are outside of the service areas defined by the transit operators via the polygons and/or do not match the demand-response service attributes for those service areas, the trip-booking system 20 reports to the requesting transit operator system 24 that no solutions were found (720), after which the method 700 ends.

If, instead, the trip pick-up and drop-off locations are within the service areas defined by the transit operators and match the demand-response service attributes for the service areas, the trip-booking system 20 transmits scheduling requests to the particular transit operator systems 24 that can service the request (724). The trip-booking system 20 then receives responses from the transit operator systems 24 indicating whether the transit operators would be able to service the trip booking (728). The responses provide at least partial scheduling solutions for the request, or an indication that no scheduling solutions are available for the request.

The trip-booking system 20 analyzes the response(s) received at 728 to determine if one or more scheduling solutions exist for the trip booking (732). Here, the trip-booking system 20 examines each response and determines if one or more transit operators can cooperatively provide a full scheduling solution for the requested trip. If no suitable solutions exist for the trip booking, the trip-booking system 20 transmits a response to the requesting transit operator system 24 that no solutions are available at 720, after which the method 700 ends. If, instead, one or more scheduling solutions are found at 732, the trip-booking system generates a ranked solution list (736). The list of scheduling solutions is ranked based on user-definable criteria such as passenger fare, total travel time, transit operator cost, etc. Additionally, the trip-booking system 20 notifies transit operator systems 24 providing scheduling solutions that do not constitute part of the ranked solution list that those scheduling solutions will not be required. The trip-booking system 20 then transmits the ranked scheduling solutions to the requesting transit operator system 24 (740).

Once the trip-booking system 20 transmits the ranked scheduling solutions at 740, it waits a pre-defined period of time (such as 120 seconds) for an election by the transit operator system 24 of one of the scheduling solutions that the trip-booking system 20 generated (744). If no election of one of the scheduling solutions is received within the pre-defined period of time, the trip-booking system 20 notifies the transit operator systems 24 offering at least partial scheduling solutions that the scheduling solutions will not be required (748). Upon notifying the transit operator systems 24, the trip-booking system 20 sends an expiry notification to the requesting transit operator system 24 (752), after which the method 700 ends. If, instead, the requesting transit operator system 24 replies within the pre-defined period of time, the trip-booking system 20 determines if a solution was selected (756). The requesting transit operator system 24 can provide a response that indicates that one of the ranked scheduling solutions was elected or that none of the ranked scheduling solutions was elected/suitable. If no solution was selected at 756, the trip-booking system 20 notifies transit operators offering scheduling solutions that they are not required (760). That is, the trip-booking system 20 sends a declination message to the transit operator systems 24 in question. After notifying the transit operators at 760, the method 700 ends. If, instead, a scheduling solution was selected in the response from the requesting transit operator system 24, the trip-booking system 20 notifies transit operators offering scheduling solutions that they are not required (760). The trip-booking system 20 sends a declination message to the transit operator systems 24 in question. Then, the trip-booking system 20 notifies the transit operator system(s) 24 offering the selected scheduling solution that the solution was selected (768). The trip-booking system 20 then waits a pre-defined period of time for the transit operator system(s) 24 to confirm that the scheduling solutions are scheduled (772). If the confirmation (s) from the transit operator system(s) 24 offering the selected scheduling solution are received within the pre-defined period of time, the trip-booking system 20 sends a confirmation notification to the requesting transit operator system 24 that the selected scheduling solution was scheduled (776), after which the method 700 ends. If, instead, the confirmation(s) from the transit operator system(s) 24 are not received within the pre-defined period of time, the trip-booking system 20 sends an expiry notification to the requesting transit operator system 24 at 752, after which the method 700 ends.

In order to describe the determination of which transit operators can provide scheduling solutions for a trip booking in more detail, a number of exemplary scenarios will be illustrated.

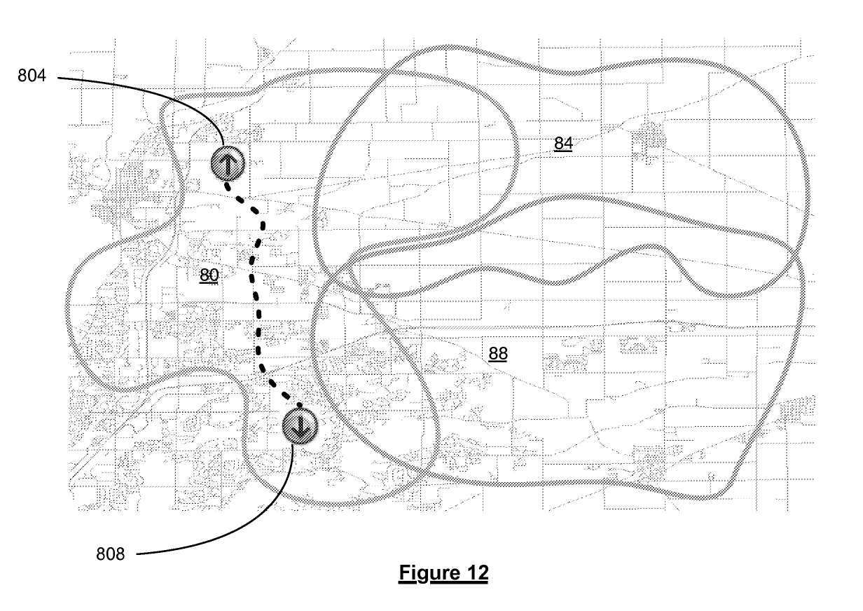

FIG. 12 shows the geographic areas of demand-response service of FIG. 4 with a customer-requested pick-up location 804 and drop-off location 808 shown. The customer pick-up location 804 and drop-off location 808 are provided by the customer to a service representative. In this case, the customer has requested a pickup time of 13:00 on a Monday. Based on the service information defined by each transit operator, the trip planning system 20 will only request scheduling solutions from transit operator A. All other transit operators will not be consulted for scheduling solutions.

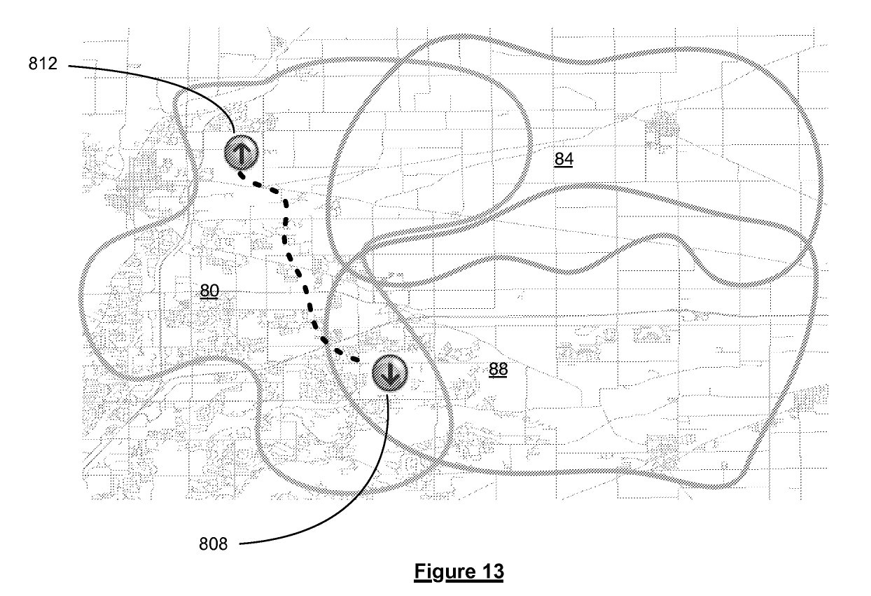

FIG. 13 shows a scenario where the pickup location 804 is the same as that shown in FIG. 13, but a new drop-off location 812 is shown lying in the region overlapped by both service area 80 and service area 88. Again, in this scenario, the customer has requested a pickup time of 13:00 on a Monday. It can be seen that the drop-off location 812 resides within transit operator B's service area. Based on the service information defined by each transit operator, the trip-booking system 20 will only request scheduling solutions from transit operator A. Transit operator B has been excluded because the pick-up location 804 is not within transit operator B's defined service area.

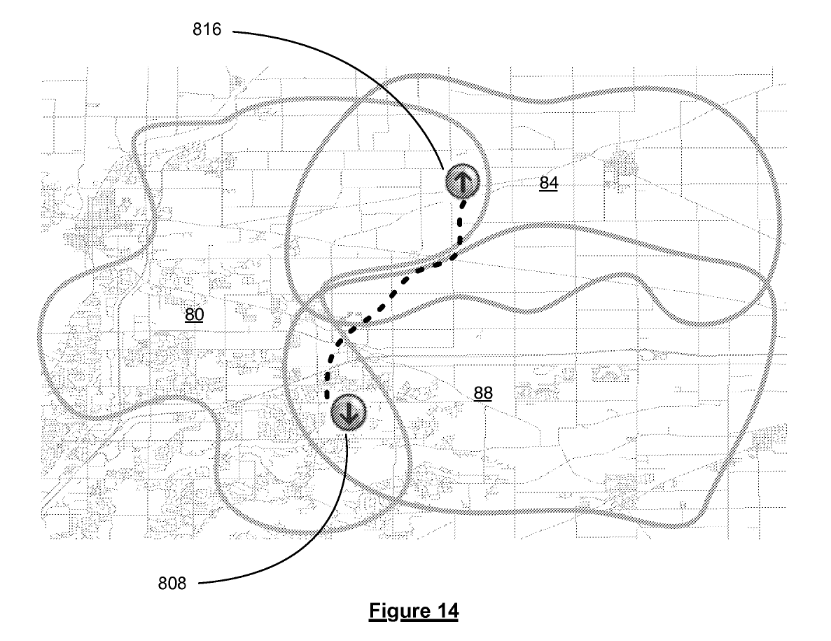

FIG. 14 shows a scenario similar to that shown in FIG. 14, except that the customer has specified a pickup location 816 that lies in the region overlapped by both service area 80 and service area 84. Again, the customer has requested a pick-up time of 13:00 on a Monday. Since transit operator B has configured the trip-booking system 20 to do pick-ups in service area 84, the trip-booking system 20 requests scheduling solutions from both transit operator A and transit operator B.

When a trip booking has been scheduled, it can be canceled or removed via a real-time interface between a transit operator system 24 and the trip-booking system 20.

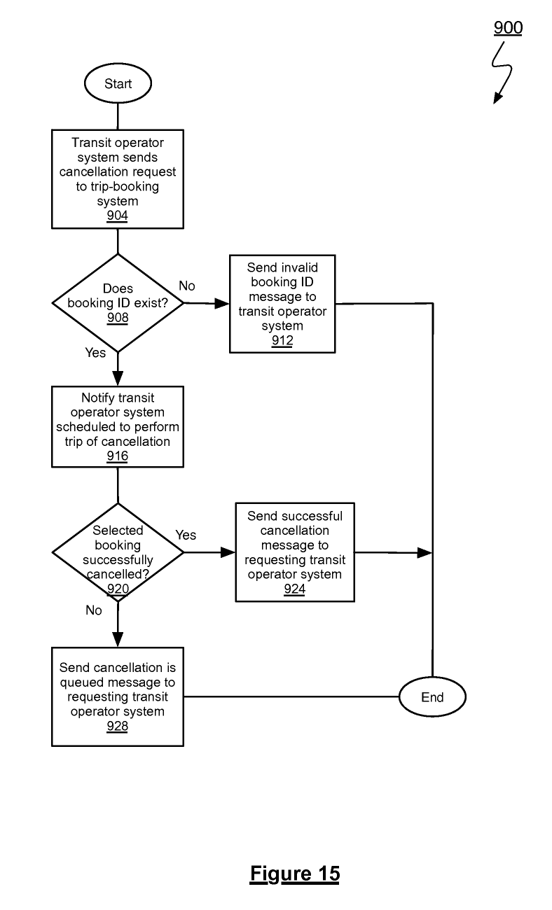

FIG. 15 shows the general method 900 of canceling or removing a scheduled trip booking. The method 900 commences with a transit operator system 24 sending a cancellation request to the trip-booking system 20 (904). The cancellation request includes the trip-booking ID. Upon receipt of the cancellation request, the trip-booking system 20 determines if the booking ID exists (908). The trip-booking system 20 searches the registered trip bookings in the trip-booking database 38 for the booking ID received. If the trip-booking ID does not exist in the trip-booking database 38, the trip-booking system 20 sends an invalid booking ID message to the transit operator system 24 (912), after which the method 900 ends. If, instead, the trip-booking system 20 locates the booking ID in the trip-booking database 38 at 908, the trip-booking system 20 notifies the transit operator system(s) 24 providing the scheduled solution(s) of the trip-booking cancellation (916). The transit operator system(s) 24, upon canceling the scheduled solution(s), reply with a cancellation confirmation. The trip-booking system 20 then determines if the trip booking was successfully cancelled (920). If cancellation confirmations were received from each transit operator system 24 providing at least part of the scheduled solution, the booking is deemed to be successfully cancelled, and the trip-booking system 20 sends a successful cancellation message to the requesting transit operator system 24 (924), after which the method 900 ends. If, instead, not all of the booking cancellation confirmations were received from all transit operator systems 24 providing at least part of the scheduled solution, the trip-booking system 20 sends a cancellation queued message to the requesting transit operator system 24 (928), after which the method 800 ends. The trip-booking system 20 will then resend cancellation messages to the transit operator system(s) 24 providing at least part of the scheduled solution and await until all cancellation confirmations have been received.

Existing trip bookings that are currently scheduled can be updated via the transit operator systems 24.

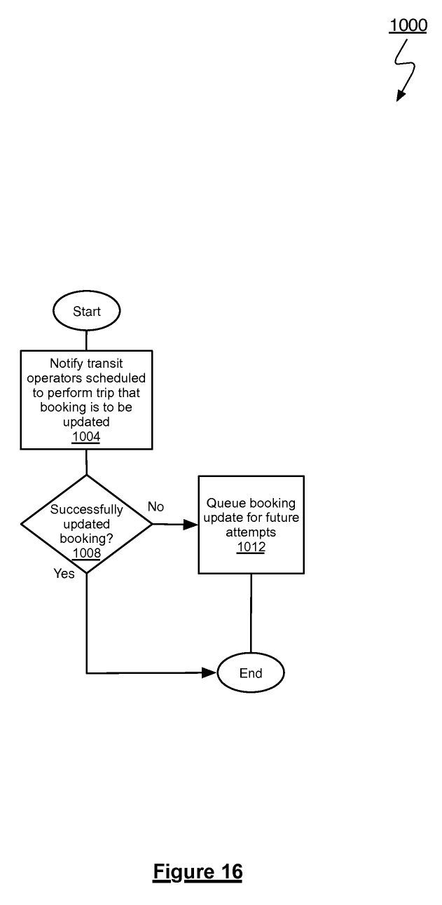

FIG. 16 illustrates the general method 1000 of updating scheduled bookings. The method 1000 commences with the trip-booking system 20 notifying transit operator systems 24 scheduled to perform a trip booking that the booking is to be updated (1004). The trip-booking system 20 then determines if the transit operator systems 24 providing the scheduled solution corresponding to the booking confirmed that the scheduled solutions were updated successfully (1008). If the trip-booking system 20 receives confirmations from all the transit operator systems 24 providing the scheduled solution corresponding to the booking, the method 1000 ends. If, instead, the trip-booking system 20 does not receive confirmations from all the transit operator systems 24 providing the scheduled solution corresponding to the booking, the booking update is queued for future attempts (1012). Here, the trip-booking system 20 repeatedly attempts to notify the transit operator systems 24 providing the scheduled solution until confirmation is received from all of the transit operator system 24, after which the method 1000 ends.

The trip-booking system 20 retrieves customer information from the central customer database 34 to determine what requirements exist for the trip being booked. The customer information retrieved from the customer database maintained by the trip-booking system 20 includes the following data elements so that a new booking can be entered:
customer ID, surname, given name(s)
list of registered addresses (e.g., home, work)
unique list of locations that client has travelled to in the past
contact information (e.g., home phone, work phone)
eligible services including affective start and end dates (e.g. ADA, Medicaid)
disabilities, mobility aids, space type, escort requirements
allowable transportation modes (e.g., demand response, fixed route)

Dispatching

The trip-booking system 20 acts as a centralized location to track trip arrival and perform times, automatic vehicle location (“AVL”) data, and no shows. To this end, the trip-booking system 20 provides a real-time interface for transit operator systems 24 to record actual rifle and to perform times four trip bookings. Although this is not the mandatory requirement four transit operators, it provides additional information regarding the trip.

The trip-booking system 20 enables transit operator systems 24 to stream that vehicle AVL data to the trip-booking system 20 and view of the current location of their vehicle via a web-based interface. Transit operators are required to send the trip-booking system 20 no show trip messages via a real-time interface. The trip-booking system 20 will not only record this information, but will also support scheduling update logic using this information for future trips. For example, if a customer no shows the trip and future trips exist for the customer, the trip-booking system 20 can be configured to automatically cancel these trips.

Funding and Faring Management

Generally, there are three types of cost categories when providing a transportation service: (a) customer fare, (b) provider cost, and (c) funding source subsidy. The customer fare is a cost associated to the passenger that is requesting the service. This cost is usually refer to as the “passenger” or “customer” fare. There are many different ways that a customer fare can be calculated:
zonal (e.g., traveling from one zone to another zone)
distance (i.e., mileage-based rates)
time (i.e., time-based rates)
flat fare (i.e., fixed rate)

The provider cost is associated to the entity that provides the transportation service for the requesting customer. This cost is usually referred to as a “provider costing” or “provider fees”. Again, there are many different ways that a provider cost can be calculated:
cost based on space type being transported (e.g., ambulatory, wheelchair)
distance (i.e., mileage-based rates)
time (i.e., time-based rates)
service rates (e.g., ADA, Medicaid)

Funding sources are entities that subsidize provider costs and/or customer fares. There are sets of rules when determining these subsidy amounts:

### Criteria

specific booking purpose (e.g., medical, education)
specific passenger types (e.g., customer, companion, child)
picking up were dropping off at a specific set of locations
specific fare types
specific services (e.g., ADA, Medicaid)
age
space type
disability type
requested time ranges
requested date ranges
day of week

### Calculations

will only subsidize a percentage of trip cost
customer must contribute a minimum copayment
provider must contribute to a minimum the amount

### Limits

will only subsidize X number of trips per customer by day, week, month or year
Will only subsidize customer trips up to a defined amount by day, week, month or year

The trip-booking system 20 is not responsible for customer fare and provider cost calculations, but will maintain the amounts for each booking that I transit operator submits to provide the service. Therefore, all customer fear of mounts and provider cost calculations are performed by the transit operator and submit it with all scheduling solution responses. The trip-booking system 20 then saves this information in the trip-booking record. However, the trip-booking system 20 enables the system administrator two set up and maintain funding source entities. The trip-booking system 20 uses this information to automatically assigned funding sources to booking records that meet defined criteria (as stated above), and automatically adjust fare/cost collections.

The trip-booking system 20 is responsible for automatically assigning (matching) the appropriate funding source for each trip booking. Therefore, it is necessary that all funding source information the registers within the trip-booking system 20. The system administrator specifies a default order for funding programs. In so doing, the order in which funding programs contribute to fare/cost subsidization is determined when multiple funding programs are available for a trip. The default order affects all trip bookings that match the funding programs' criteria. When more than one funding source meets the trip-booking criteria, calculation start with the first program in the selected order, with any remaining fare/cost amount being subsidized (and limited, if applicable) by subsequent programs on the list.

Computer-executable instructions for implementing the trip-booking software on a computer system could be provided separately from the computer system, for example, on a computer-readable medium (such as, for example, an optical disk, a hard disk, a USB drive or a media card) or by making them available for downloading over a communications network, such as the Internet.

While the invention has been described with specificity to a customer representative-facing system, other types of implementations will occur to those of skill in the art. For example, certain functions can be made accessible to customers via a web or IVR interface.

Any type of computer-readable storage can be used to store customer profiles and the computer-executable instructions for providing the trip-booking software.

The trip-booking system may be integrated with a transit operator system.

While the computer system is shown as a single physical computer, it will be appreciated that the computer system can include two or more physical computers in communication with each other. Accordingly, while the embodiment shows the various components of the trip-booking system residing on the same physical computer, those skilled in the art will appreciate that the components can reside on separate physical computers. Further, the computer system can be any type of computing device that is configured to provide the requisite functionality.

The above-described embodiments are intended to be examples of the present invention and alterations and modifications may be effected thereto, by those of skill in the art, without departing from the scope of the invention that is defined solely by the claims appended hereto.

What is claimed is:

1. A computer system for sharing demand-response data, comprising:
a communications interface for communicating with transit operator systems of transit operators;
a storage storing customer profiles from said transit operators for customers thereof, said customer profiles including customer data; and
computer-executable instructions executed by at least one processor of said computer system for synchronizing said customer profiles with said transit operator systems.

2. The computer system of claim 1, further comprising:
demand-response service data stored in said storage, said service area data defining service areas serviced by said transit operators and demand-response service attributes for each of said service areas.

3. The computer system of claim 2, wherein said demand-response service attributes include at least one of periods of operation, pick-up and drop-off rules for the service areas, service types and transfer points between neighboring service areas.

4. The computer system of claim 2, further comprising:
a trip-booking module for receiving a trip request and for identifying a subset of said transit operators that can service said trip request based on said demand-response service data.

5. The computer system of claim 4, wherein said trip-booking module assembles a list of scheduling solutions for said trip request.

6. The computer system of claim 5, wherein said list of scheduling solutions is ranked based on at least one of: passenger fare, total travel time, and transit operator cost.

7. The computer system of claim 4, wherein said trip-booking module requests scheduling solutions from said transit operator systems of said subset of transit operators.

8. The computer system of claim 7, wherein said transit operator systems include at least one of customer cost and provider cost for said scheduling solutions.

9. The computer system of claim 4, wherein said trip-booking module enables editing and cancellation of trips.

10. The computer system of claim 4, wherein said customer profiles store transit requirements for said customers.

11. The computer system of claim 10, wherein said subset of said transit operators is selected at least partially based on said requirements of said customer for which said trip booking is being planned.

12. The computer system of claim 2, wherein said customer profiles store transit requirements for said customers.

13. The computer system of claim 2, further comprising:
a graphical user interface for enabling transit operators to define said service areas via polygons overlaid on a street network.

14. The computer system of claim 1, wherein said customer profiles include a central customer ID used by said computer system and said transit operator systems to refer to a particular customer.

15. The computer system of claim 1, wherein said computer-executable instructions when executed by said at least one processor translate at least one data element in said customer profiles when synchronizing with at least one of said transit operator systems.

16. A method for sharing demand-response data, comprising:
receiving customer profiles including customer data from transit operator systems;
storing said customer profiles from said transit operators in storage of a computer system; and
sending said customer profiles to other said transit operator systems.

17. The method of claim 16, further comprising:
storing demand-response service data in said storage, said service area data defining service areas serviced by said transit operators and demand-response service attributes for each of said service areas.

18. The method of claim 17, wherein said demand-response service attributes include at least one of periods of operation, pick-up and drop-off rules for the service areas, service types and transfer points between neighboring service areas.

19. The method of claim 17, further comprising:
receiving a trip request; and
identifying a subset of said transit operators that can service said trip request based on said demand-response service data.

20. The method of claim 19, further comprising:
assembling a list of scheduling solutions for said trip request.

21. The method of claim 20, wherein said list of scheduling solutions is ranked based on at least one of: passenger fare, total travel time, and transit operator cost.

22. The method of claim 19, further comprising:
requesting scheduling solutions from said transit operator systems of said subset of transit operators.

23. The method of claim 22, further comprising:
receiving said scheduling solutions with at least one of customer cost and provider cost for said scheduling solutions.

24. The method of claim 19, further comprising:
providing an interface for editing and cancelling trips.

25. The method of claim 19, wherein said customer profiles store transit requirements for said customers.

26. The method of claim 25, wherein said subset of said transit operators is identified at least partially based on said requirements of said customer for which said trip booking is being planned.

27. The method of claim 17, wherein said customer profiles store transit requirements for said customers.

28. The method of claim 17, further comprising:
providing a graphical user interface for enabling transit operators to define said service areas via polygons overlaid on a street network.

29. The method of claim 16, wherein said storing said customer profiles comprises:
storing a central customer ID used by said computer system and said transit operator systems to refer to a particular customer with said customer profiles.

30. The method of claim 16, further comprising:
translating at least one data element in said customer profiles when synchronizing with at least one of said transit operator systems.
